(19) United States
(12) Patent Application Publication
(10) Pub. No.: US 2012/0243852 A1
(43) Pub. Date: Sep. 27, 2012

(54) METHODS OF PERFORMING SCHEDULED RECORDING IN HOME NETWORK SYSTEM AND DIGITAL MEDIA SERVER AND DIGITAL MEDIA PLAYER FOR PERFORMING THE SAME

(76) Inventor: Jin Gon KIM, Seoul (KR)

(21) Appl. No.: 13/421,382

(22) Filed: Mar. 15, 2012

(30) Foreign Application Priority Data
Mar. 24, 2011 (KR) 10-2011-0026404

(51) Int. Cl. H04N 5/76

(52) U.S. Cl. 386/291; 386/E05.001

(57) ABSTRACT

A method of performing schedule recording in a home network system is provided that includes receiving a pre-registered reserved word from a terminal and searching a content corresponding to the reserved word and transmitting a reservation list including information on the searched content to a terminal indicated by the reserved word, wherein receiving the pre-registered reserved word and transmitting a reservation list are performed by a digital media server.

### CROSS-REFERENCE TO RELATED APPLICATION

This application claims priority to Korean Patent Application No. 10-2011-0026404 filed on Mar. 24, 2011, the contents of which are herein incorporated by reference in its entirety.

### BACKGROUND OF THE INVENTION

1. Technical Field

Embodiments of the present invention are directed to a schedule recording method in a home network system.

2. Discussion of the Related Art

There are ongoing efforts for the DLNA (Digital Living Network Alliance) standardization that is directed to establishment of guidelines needed to be observed for interoperability between various devices in homes/offices and authentication of observance of the guidelines. The DLNA standard allows a diversity of devices, such as digital AV devices or personal computers, connected over a home network to have interoperability so that contents including music and movie files or still images can be shared between the devices in the home network.

DLNA authenticated devices can be compatible with each other via wired or wireless networks. That is, the DLNA allows digital devices, such as

DLNA authenticated devices can be compatible with each other via wired or wireless networks. That is, the DLNA allows digital devices, such as home appliances, PCs, or radio devices, produced from different manufacturers to be coupled to one another over a wired or wireless home network to share contents based on UpnP (Universal Plug and Play).

From such features of the DLNA, contents sharing can be available between DLNA authenticated terminals. To search for contents stored in one or more DLNA authenticated terminals having storage, a text-based inquiry is transmitted to the terminals and each terminal searches contents similar to the inquiry and shares the searched contents with other DLNA authenticated devices over the home network.

### SUMMARY OF THE INVENTION

When a user receives and plays contents corresponding to pre-registered content information in a home network system, if the contents at play have been already viewed or are not the ones the user wanted, there is no way to cancel recording off the contents, thus causing inconvenience upon schedule recording in the home network system.

Exemplary embodiments of the present invention provide a schedule recording method that can enhance user convenience in a home network system and a digital media server and digital media player for a home network system, which can perform the schedule recording.

According to an embodiment of the present invention, there is provided a method of performing schedule recording in a home network system, including receiving a pre-registered reserved word from a terminal and searching a content corresponding to the reserved word and transmitting a reservation list including information on the searched content to a terminal indicated by the reserved word, wherein receiving the pre-registered reserved word and transmitting a reservation list are performed by a digital media server.

The reserved word includes at least one of a keyword, an inquiry, schedule information, and terminal information for indicating a digital media player registered in the digital media server.

The content information includes at least one of image size information of the content, a title of the content, information on time when the content is aired, and image quality information.

The digital media server searches the content corresponding to the reserved word from a content source.

The method further includes when recording cancellation is selected on a specific content among a plurality of contents included in the content information, stopping recording the specific content streamed from the content source in response to a recording cancelling request from the terminal, wherein stopping is performed by the digital media server.

The method further includes deleting the recording cancelling requested content from the reservation list and updating the reservation list.

The method further includes when recording is selected on a specific content among a plurality of contents included in the content information, downloading the specific content from the content source in response to a content recording request from the terminal and initiating recording of the specific content.

The method further includes when playing is selected on a specific content among a plurality of contents included in the content information, downloading the specific content from the content source in response to a specific content transmitting request from the terminal and streaming the specific content to the terminal.

According to an embodiment of the present invention, there is provided a digital media server used for a home network system including a content processor configured to search a content corresponding to a pre-registered reserved word and to transmit a reservation list including information on the searched content to a terminal indicated by the reserved word.

The digital media server further includes a content storage configured to store the reservation list.

The digital media server further includes a reserved word analyzer configured to analyze a reserved word from a terminal and to generate a search word for searching a content source, wherein the content processor includes a content information generating unit configured to receive information on a content corresponding to the search word from the content source, to generate a reservation list including the content information, and to transmit the reservation list to the terminal indicated by the reserved word, a content downloading unit configured to download a corresponding specific content from the content source in response to a content recording request from the terminal, a content streaming control unit configured to perform control so that in response to a recording cancelling request from the terminal the recording cancelling requested content streamed from the content source stops being recorded, and a content streaming unit configured to stream the corresponding specific content downloaded from the content source to the terminal in response to a corresponding specific content transmitting request from the terminal.

The content information generating unit is configured to delete the recording cancelling requested content from the reservation list and to update the reservation list.

The reserved word includes at least one of a keyword, an inquiry, schedule information, and terminal information for indicating a digital media player registered in the digital media server, and wherein the content information includes at least one of image size information of the content, a title of the content, information on time when the content is aired, and image quality information.

According to an embodiment of the present invention, there is provided a digital media player used for a home network system including a content processor configured to receive a reservation list including information on a content corresponding to a reserved word input from a user from a digital media server in the home network system and to provide a recording cancelling request to the digital media server when recording cancellation is selected by the user on a content included in the reservation list.

The digital media player further includes a reserved word processor configured to transmit a reserved word input from the user to the digital media server, wherein the content processor includes a content play control unit configured to generate a recording request command for requesting that among contents included in the reservation list a specific content selected by the user be recorded by the digital media server, to generate a recording cancelling request command for requesting cancellation of the recording, and to perform control so that among the contents included in the reservation list the specific content selected by the user to be played is streamed and played from the digital media server, a content downloading unit configured to download the specific content selected by the user to be played among the contents included in the reservation list from the digital media server, and a content playing unit configured to play the specific content selected by the user to be played among the contents included in the reservation list.

According to the embodiments of the present invention, in the case that a user receives and plays contents corresponding to pre-registered content information in a home network system, when the contents at play have been already viewed or are not the ones the user wanted, for example when the contents do not have such quality as is desired by the user, the user may cancel recording of the contents thus preventing the contents from being unnecessarily recorded or played.

### BRIEF DESCRIPTION OF THE DRAWINGS

FIG. 1 is a view illustrating an exemplary structure of a DLNA based home network according to an embodiment of the present invention;

FIGS. 2A and 2B are flowcharts illustrating the flow of messages between a DMP and a DMS to search and replay a content corresponding to a pre-registered reserved word according to an embodiment of the present invention;

FIG. 3 is a table illustrating registering a terminal and a keyword as a reserved word according to an embodiment of the present invention.

FIG. 4 is a view illustrating a screen configuration for selecting recording cancelling from a DMP according to an embodiment of the present invention. Here, the DMP may be an mDMP;

FIG. 5 is a block diagram illustrating a configuration of a digital media player (DMP) according to an embodiment of the present invention; and

FIG. 6 is a block diagram illustrating a configuration of a digital media server (DMS) according to an embodiment of the present invention.

### DESCRIPTION OF THE EMBODIMENTS

The present invention may be embodied by various modifications. Hereinafter, some embodiments are described with reference to the accompanying drawings. However, the present invention should not be construed as limited thereto and rather as including all modifications, equivalents, or substitutes within the scope of the present invention. The same reference numerals may be used to denote the same or substantially the same elements throughout the specification and the drawings.

The terms “first”, “second”, “A”, and “B” may be used to describe various elements without being limited thereto. The above terms may be used only for purposes of distinguishing one element from another. For example, without departing from the scope of the invention, a first element may be named as a second element, and the second element may be likewise named as the first element. As used herein, the term “and/or” includes any and all combinations of one or more of the associated listed items.

It will be understood that when an element or layer is referred to as being “connected to” or “coupled to” another element, it can be directly connected or coupled to the other element or intervening elements may be present. In contrast, when an element is referred to as being “directly connected to” or “directly coupled to” another element, there are no intervening elements present.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the “digital media player (DMP)” includes a DMP and/or an mDMP (mobile Digital Media Player).

Hereinafter, the embodiments of the present invention will be described in greater detail with reference to the accompanying drawings.

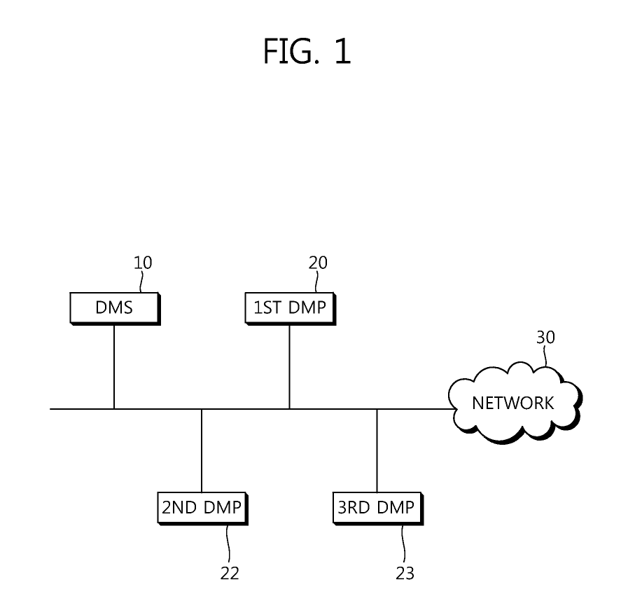

FIG. 1 illustrates an exemplary structure of a DLNA based home network according to an embodiment of the present invention.

The DLNA based home network includes a DMS 10, a plurality of DMPs and/or mDMPs 20, 22, and 23.

The DMS (Digital Media Server) 10 provides media contents over the DLNA based home network. A settop box, desktop, or laptop computer of supporting mobility may serve as the DMS. Referring to FIG. 1, the DMS 10 is connected to the first DMP 20 to third DMP 23 through a network 30. The DMPs (Digital Media Players) 21 to 23 select, control, and replay media contents over the home network. According to an embodiment, each DMP may include a DMS function, and according to an embodiment, the DMS may include a DMP function. The DMS 10 may be connected to the DMPs 21, 22, and 23 via a wired or wireless home network.

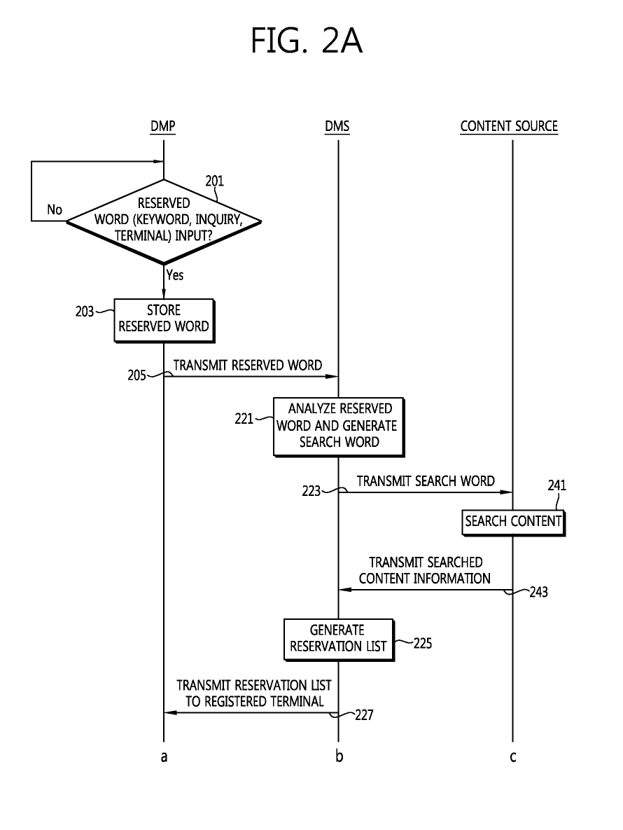

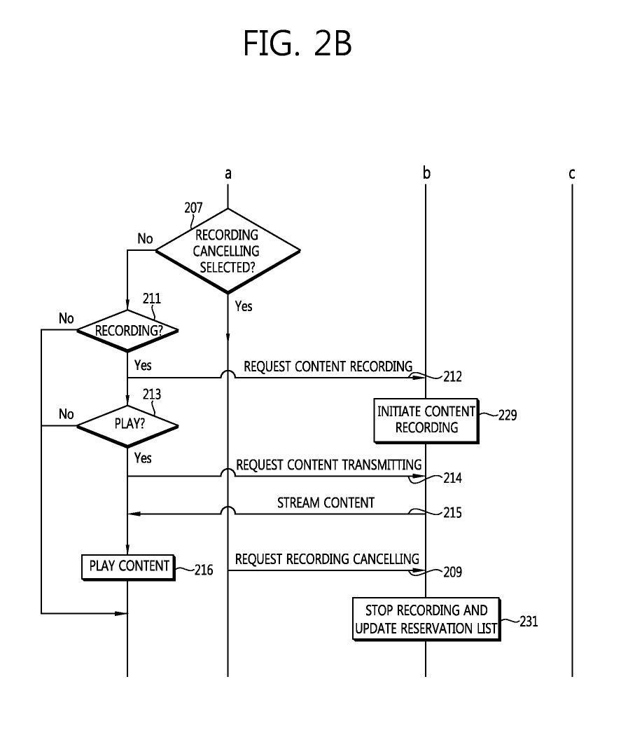

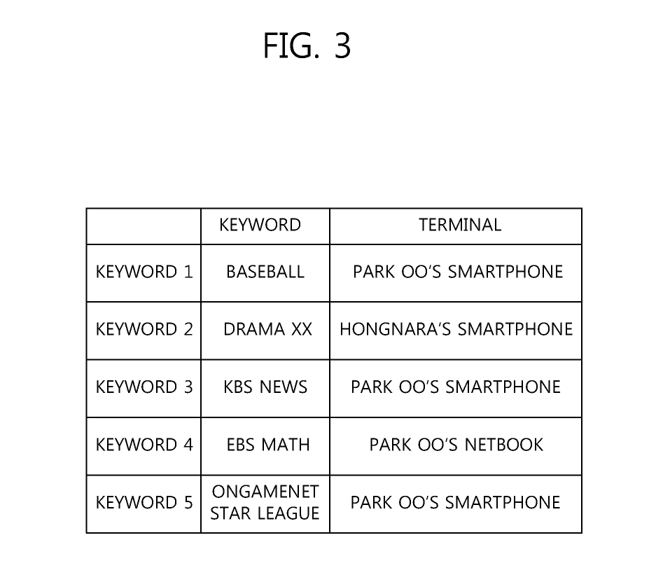

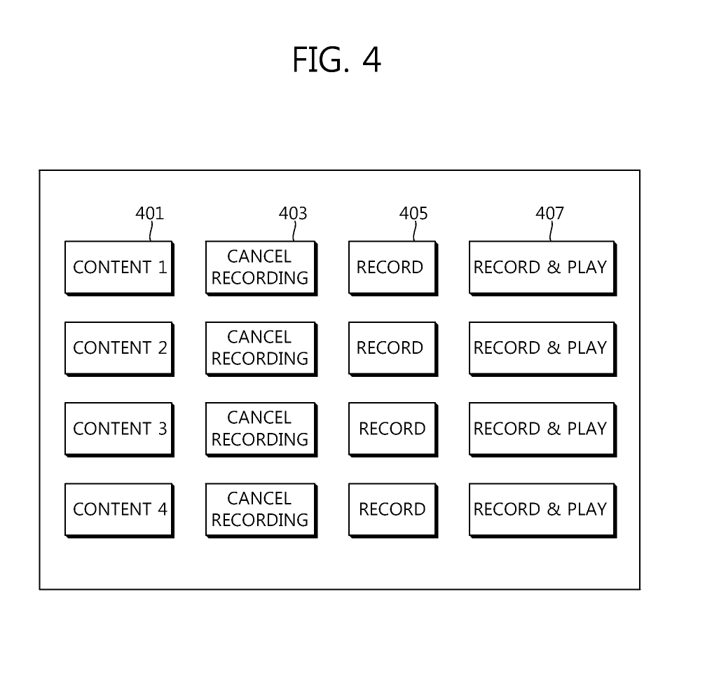

FIGS. 2A and 2B are flowcharts illustrating the flow of messages between a DMP and a DMS to search and replay a content corresponding to a pre-registered reserved word according to an embodiment of the present invention. FIG. 3 is a table illustrating registering a terminal and a keyword as a reserved word according to an embodiment of the present invention. FIG. 4 is a view illustrating a screen configuration for selecting recording cancelling from a DMP according to an embodiment of the present invention. Here, the DMP may be an mDMP.

Referring to FIG. 2A, the DMP identifies whether a reserved word is entered by a user (S201), and when the reserved word is entered, stores the reserved word (S203). When the reserved word is not entered, the DMP repeats step S201 until the reserved word is entered. The DMP may be a mobile terminal, such as, for example, a smartphone, a netbook, a laptop computer, or the like. The reserved word may be a keyword, an inquiry, schedule information, terminal information, etc. The terminal information is information on the DMP, which is registered in the DMS, and may be unique information for a terminal device, which is used to indicate a target terminal for streaming a content corresponding to the reserved word.

When a user registers, as shown in FIG. 3, “baseball” and “Park OO's smartphone”, “drama XX” and “Hongnara's smartphone”, “KBS news” and “Park OO's smartphone”, “EBS math” and “Park OO's netbook”, “OnGameNet Star league” and “Park OO's smartphone” as the keyword and terminal information, respectively, the user may search a content associated with a registered keywords from a contents source and may stream the associated content using a corresponding registered terminal.

According to an embodiment, a single terminal or two or more different terminals may be registered. In the case that two terminals are registered, the searched content corresponding to the input keyword may be streamed to the two registered terminals in a multicast manner. The keywords may be registered in further detail. For example, keywords limited to baseball games between Samsung and SK, drama XX aired on February 10, KBS news to be aired at nine o'clock, March 25 may be registered.

After storing the reserved word, the DMP transmits the reserved word to the DMS for registration (S205). According to an embodiment, the DMP may transmit the entered reserved word to the DMS before storing the reserved word.

The DMS analyzes the transmitted reserved word and generates a search word for searching the content source (S221). Alternatively, the DMS may search the content source using the reserved word alone without separately generating the search word. The content source may be a broadcasting server positioned outside the home network or may be a content server connected to the DMS through a wideband network, such as the Internet. Or the content server may be another DMS in the home network.

The DMS transmits the generated search word to the content source (S223), determines whether the content source includes a content corresponding to the search word (S241), and transmits information on the searched contents to the DMS (S243).

The DMS receives the transmitted content information, generates a reservation list (S225), and transmits the reservation list including the content information to a predetermined terminal (S227). The information on the searched contents may be made as the reservation list. The registered terminal may be a DMP. The content information may include image size information, title, time information, and SD/HD image quality information of the content. The time information may include information on a time when the content is aired. The reservation list may be configured to include content information containing the image size information, title, time information, and SD/HD image quality information of the content.

Alternatively, in step S227, the DMS may transmit the content information alone to the DMP.

A user determines whether a specific content included in the content information requires recording in consideration of whether the content repeats, whether the content is viewable at the time, and the quality (SD/HD) of the content.

Specifically, referring to FIG. 2B, it is determined whether “Cancel recording” is selected for the specific content (S207). When the “Cancel recording” is selected, the DMP transmits a recording cancelling request to the DMS (S209). Receiving the recording cancelling request, the DMS stops recording the recording cancel requested content that is streamed from the content source and deletes the recording cancel requested content from the reservation list thereby updating the reservation list (S231).

When the “Cancel recording” is not selected for the specific content, it is determined whether “Record” is selected (S211). When “Record” is selected, a content recording request is transmitted to the DMS (S212). In response to the content recording request, the DMS downloads a corresponding specific content from the content source and initiates recording of the content (S229). The recording may be initiated at a corresponding broadcast time based on the broadcast start time in the content information. When the “Cancel recording” is selected after the recording has been started at the corresponding broadcast initiation time, the recording may be stopped.

When “Play” is selected, a transmitting request of a corresponding specific content is transmitted to the DMS (S214). In response to the transmitting request, the DMS downloads the corresponding specific content from the content source and streams the corresponding specific content to the DMP (S215), and the DMP receives and plays the streamed content (S216).

For example, as shown in FIG. 4, a user interface may be configured so that when a user selects “Cancel recording” 403 for “Content 1” 401, the recording cancelling operation (steps S209 and S231) of the content is performed, when the user selects “Record” 405, the recording operation (steps S212 and S229) of the content is performed, and when the user selects “Record&Play” 407, the recording operation (steps S212 and S229) and playing operation (steps S214, S215, and S216) are performed.

As described above, at the time that the DMS starts recording, the registered terminal may receive the stored content in a streaming manner and may play the stored content a predetermined time (about two seconds) after the time that the content is stored so that the content may be viewed by a user or may execute cancellation of the recording so that meaningless contents are not accumulated in the DMS.

According to an embodiment, only when the DMP is connected to the Internet inside or outside the home network, the DMS may stream a corresponding content to the DMP or DMP may perform control, such as cancellation of recording.

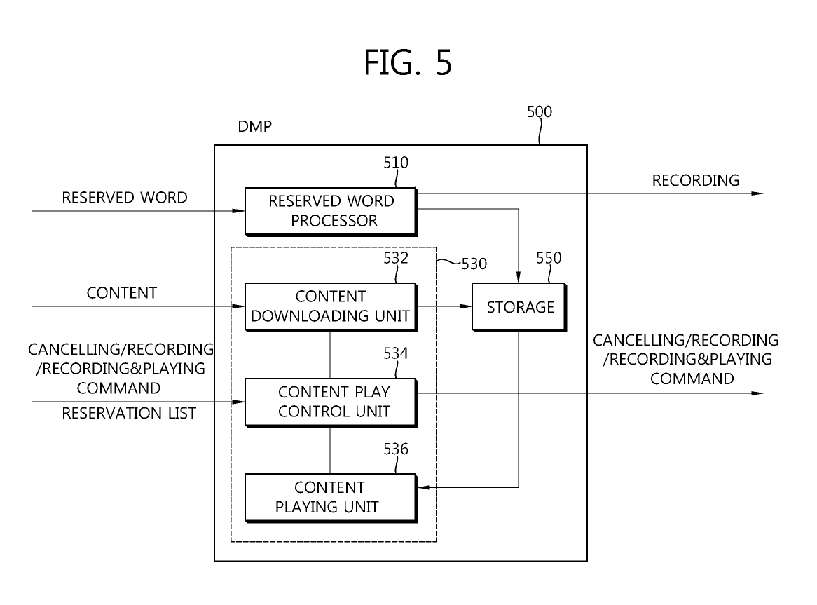

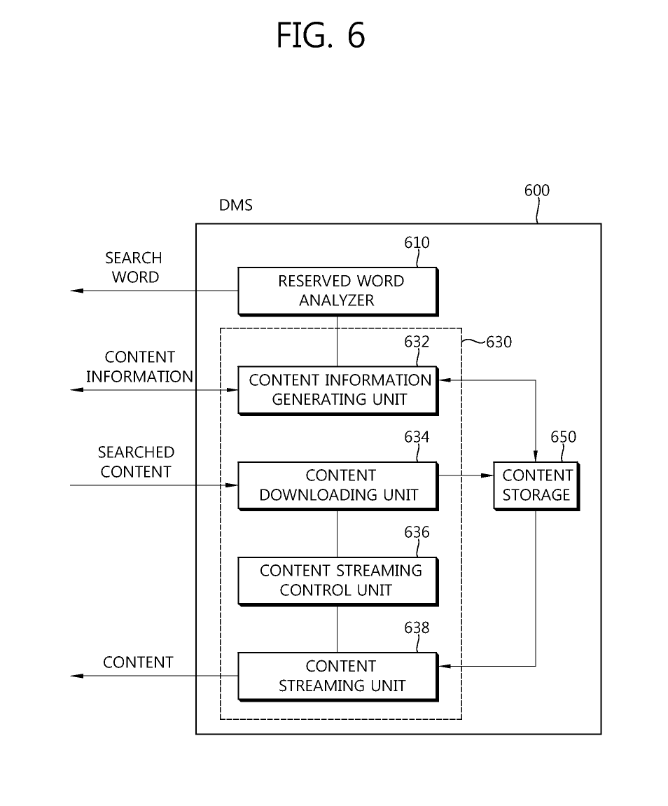

FIG. 5 is a block diagram illustrating a configuration of a digital media player (DMP) according to an embodiment of the present invention, and FIG. 6 is a block diagram illustrating a configuration of a digital media server (DMS) according to an embodiment of the present invention. The DMS may include a settop box. According to an embodiment, the DMS may include any device accessible to the Internet, such as an IPTV, smart TV, personal computer, or the like. The DMP may include a portable terminal, such as, for example, a smartphone, laptop computer, netbook computer, or the like. The DMP may include an mDMP.

Referring to FIG. 5, the DMP 500 includes a reserved word processor 510 and a content processor 530. According to an embodiment, the DMP 500 may further include a storage 550. The content processor 530 includes a content downloading unit 532, a content play control unit 534, and a content playing unit 536. Although the content downloading unit 532, the content play control unit 534, and the content playing unit 536 may be implemented as respective functional blocks to perform respective corresponding functions as shown in FIG. 5, the units 532, 534, and 536 may be alternatively embodied as a single functional block that may perform the whole functions. Although the content play control unit 534 and the content playing unit 536 may be implemented as respective functional blocks to perform respective corresponding functions as shown in FIG. 5, the units 534 and 536 may be alternatively embodied as a single functional block that may perform the whole functions.

Referring to FIG. 5, the reserved word processor 510 may receive a reserved word from a user and may transmit the reserved word to the DMS. The reserved word may be stored in the storage 550.

The content processor 530 requests that the DMS record or cancel recording of a specific content selected by a user among contents in the reservation list. Alternatively, the content processor 530 receives a specific content selected by a user to be played among the contents in the reservation list in a streaming manner and plays the specific content.

The content play control unit 530 generates a recording request command for requesting that the DMS record the specific content selected by the user among the contents in the reservation list or generates a recording cancelling request command for requesting cancellation of the recording. Alternatively, the content play control unit 530 performs control so that the specific content selected by the user to be played among the contents in the reservation list is downloaded from the DMS through the downloading unit 520 and played by the content playing unit 540.

The content downloading unit 520 downloads the specific content selected by the user to be played among the contents in the reservation list from the DMS and stores the specific content in the storage 550.

The content playing unit 540 fetches the specific content selected by the user to be played among the contents in the reservation list from the storage 550 and plays the specific content.

Referring to FIG. 6, the DMS 600 includes a reserved word analyzer 610 and a content processor 630. According to an embodiment, the DMS 600 may further include a storage 650. The content processor 630 includes a content information generating unit 632, a content downloading unit 634, a content streaming control unit 636, and a content streaming unit 638.

Although the content information generating unit 632, the content downloading unit 634, the content streaming control unit 636, and the content streaming unit 638 may be implemented as respective functional blocks that perform respective corresponding functions as shown in FIG. 6, the content information generating unit 632, the content downloading unit 634, the content streaming control unit 636, and the content streaming unit 638 may be alternatively embodied as a single block that may perform the whole functions. According to an embodiment, although the content information generating unit 632 and the content downloading unit 634 may be implemented as respective functional blocks that perform respective corresponding functions as shown in FIG. 6, the content information generating unit 632 and the content downloading unit 634 may be alternatively embodied as a single block that may perform the whole functions.

According to an embodiment, although the content streaming control unit 636 and the content streaming unit 638 may be implemented as respective functional blocks that perform respective corresponding functions as shown in FIG. 6, the content streaming control unit 636 and the content streaming unit 638 may be alternatively embodied as a single block that may perform the whole functions.

The reserved word analyzer 610 analyzes a reserved word transmitted from the DMP, generates a search word for searching a content source, and transmits the generated search word to a searched content source.

When a user selects a function, such as “Record”, “Cancel recording”, and “Play”, on a specific content included in the content information, the content processor 630 performs an operation, such as recording the content, cancellation of the content recording, or content streaming process, in response to a request from the DMP according to a selected function. Specifically, the content processor 630 receives the content information from the content source, generates a reservation list, downloads a corresponding specific content from the content source in response to a content recording request from the DMP, enables a recording cancelling requested content streamed from the content source in response to a recording cancelling request from the DMP, downloads the corresponding specific content from the content source in response to a corresponding specific content transmitting from the DMP, and streams the corresponding specific content to the DMP.

The content information generating unit 632 receives content information on a content corresponding to the search word from the content source, generates a reservation list including the content information, and transmits the reservation list to a pre-registered terminal. The content information may include image size information, title, time information, or SD/HD image quality information of the content. The time information may include information on a time when the content is aired. The reservation list may be configured to include content information containing image size information, title, time information, or SD/HD image quality information of the content.

The content downloading unit 634 downloads a recording requested specific content from the content source in response to a content recording request from the DMP. The downloaded specific content may be stored in the content storage 650.

The content streaming control unit 636 controls the content downloading unit 634 in response to a recording cancelling request from the DMP so that the recording cancelling requested content stops being downloaded from the content source. The recording cancelling requested content is deleted from the reservation list which is then updated.

When a user selects “Play”, the content streaming control unit 636 performs control so that a corresponding specific content from the content source is downloaded in response to a corresponding specific content transmitting request from the DMP and the corresponding specific content is streamed to the DMP.

When the user selects “Play”, the content streaming unit 638 streams the corresponding specific content downloaded from the content source to the DMP in response to a corresponding specific content transmitting request from the DMP.

FIGS. 5 and 6 illustrate only main components of the DMS and DMP. The remaining components constituting the DMS and DMP are defined in the DLNA standard.

Although it has been described that the content information is transmitted from the DMS to the DMP, the embodiments of the present invention are not limited thereto. The embodiments of the present invention may also apply to where content information is transmitted from the DMS to a digital media controller (DMC).

In the case that the content information is transmitted from the DMS to the DMC and played by a digital media renderer (DMR), the content information may be provided from the DMS to the DMC, and the DMC may select functions, such as recording, cancellation of recording, or play, of a specific content included in the transmitted content information. For example, when a playing function is selected, the specific content may be played by the DMR.

The invention has been explained above with reference to exemplary embodiments. It will be evident to those skilled in the art that various modifications may be made thereto without departing from the broader spirit and scope of the invention. Further, although the invention has been described in the context its implementation in particular environments and for particular applications, those skilled in the art will recognize that the present invention's usefulness is not limited thereto and that the invention can be beneficially utilized in any number of environments and implementations. The foregoing description and drawings are, accordingly, to be regarded in an illustrative rather than a restrictive sense.

What is claimed is:

1. A method of performing schedule recording in a home network system, comprising:
receiving a pre-registered reserved word from a terminal and searching a content corresponding to the reserved word; and
transmitting a reservation list including information on the searched content to a terminal indicated by the reserved word, wherein receiving the pre-registered reserved word and transmitting a reservation list are performed by a digital media server.

2. The method of claim 1, wherein the reserved word includes at least one of a keyword, an inquiry, schedule information, and terminal information for indicating a digital media player registered in the digital media server.

3. The method of claim 2, wherein the content information includes at least one of image size information of the content, a title of the content, information on time when the content is aired, and image quality information.

4. The method of claim 2, wherein the digital media server searches the content corresponding to the reserved word from a content source.

5. The method of claim 4, further comprising:
when recording cancellation is selected on a specific content among a plurality of contents included in the content information, stopping recording the specific content streamed from the content source in response to a recording cancelling request from the terminal, wherein stopping is performed by the digital media server.

6. The method of claim 5, further comprising:
deleting the recording cancelling requested content from the reservation list and updating the reservation list.

7. The method of claim 4, further comprising:
when recording is selected on a specific content among a plurality of contents included in the content information, downloading the specific content from the content source in response to a content recording request from the terminal and initiating recording of the specific content.

8. The method of claim 4, further comprising:
when playing is selected on a specific content among a plurality of contents included in the content information, downloading the specific content from the content source in response to a specific content transmitting request from the terminal and streaming the specific content to the terminal.

9. A digital media server used for a home network system comprising:
a content processor configured to search a content corresponding to a pre-registered reserved word and to transmit a reservation list including information on the searched content to a terminal indicated by the reserved word.

10. The digital media server of claim 9, further comprising a content storage configured to store the reservation list.

11. The digital media server of claim 9, further comprising a reserved word analyzer configured to analyze a reserved word from a terminal and to generate a search word for searching a content source, wherein the content processor comprises,
a content information generating unit configured to receive information on a content corresponding to the search word from the content source, to generate a reservation list including the content information, and to transmit the reservation list to the terminal indicated by the reserved word,
a content downloading unit configured to download a corresponding specific content from the content source in response to a content recording request from the terminal,
a content streaming control unit configured to perform control so that in response to a recording cancelling request from the terminal the recording cancelling requested content streamed from the content source stops being recorded, and
a content streaming unit configured to stream the corresponding specific content downloaded from the content source to the terminal in response to a corresponding specific content transmitting request from the terminal.

12. The digital media server of claim 11, wherein the content information generating unit is configured to delete the recording cancelling requested content from the reservation list and to update the reservation list.

13. The digital media server of claim 9, wherein the reserved word includes at least one of a keyword, an inquiry, schedule information, and terminal information for indicating a digital media player registered in the digital media server, and wherein
the content information includes at least one of image size information of the content, a title of the content, information on time when the content is aired, and image quality information.

14. A digital media player used for a home network system comprising:
a content processor configured to receive a reservation list including information on a content corresponding to a reserved word input from a user from a digital media server in the home network system and to provide a recording cancelling request to the digital media server when recording cancellation is selected by the user on a content included in the reservation list.

15. The digital media player of claim 14, further comprising a reserved word processor configured to transmit a reserved word input from the user to the digital media server, wherein the content processor comprises,
a content play control unit configured to generate a recording request command for requesting that among contents included in the reservation list a specific content selected by the user be recorded by the digital media server, to generate a recording cancelling request command for requesting cancellation of the recording, and to perform control so that among the contents included in the reservation list the specific content selected by the user to be played is streamed and played from the digital media server,
a content downloading unit configured to download the specific content selected by the user to be played among the contents included in the reservation list from the digital media server, and
a content playing unit configured to play the specific content selected by the user to be played among the contents included in the reservation list.
